(19) United States
(12) Patent Application Publication
(10) Pub. No.: US 2005/0079345 A1
(43) Pub. Date: Apr. 14, 2005

(54) Polyolefin fibres and their use in the preparation of nonwovens with high bulk and resilience

(76) Inventors: Susanne Dahl Thomsen, Tistrup (DK); Torben Laigaard Mikkelsen, Esbjerg (DK); Mikael Moller, Esbjerg (DK); Flemming Faurby Stengaard, Varde (DK)

Correspondence Address: BIRCH STEWART KOLASCH & BIRCH, PO BOX 747, FALLS CHURCH, VA, 22040-0747, US

(21) Appl. No.: 10/662,350

(22) Filed: Sep. 16, 2003

Related U.S. Application Data
(60) Provisional application No. 60/411,750, filed on Sep. 19, 2002.

(30) Foreign Application Priority Data
Sep. 17, 2002 (DK) PA 2002 01368

(51) Int. Cl. D04H 3/00; B32B 27/04; D04H 5/00; B32B 9/00; D02G 3/00

(52) U.S. Cl. 428/361; 428/365; 428/372; 428/375; 428/378; 428/391; 428/392; 442/97; 442/99; 442/414; 264/211.22

(57) ABSTRACT

Non-woven materials from polyolefin-based fibres which have bulk and resilience comparable to polyester fibres are described herein, thus expanding the utility of polyolefin fibres and nonwovens to a plethora of industrial applications which previously excluded products based on polyolefin fibres due to their hitherto inadequate bulk or resilience. Control of polyolefin fibre characteristics such as the fibre/fibre friction, fibre crystallinity, draw ratio, or selection of the spin finish so as to comprise essentially of an aqueous emulsion of polysiloxanes render them suitable for preparing bulky and resilient nonwovens.

### FIELD OF INVENTION

Bulky polyolefins non-wovens are obtained by control of polyolefin fibre characteristics. The fibre/fibre friction and crystallinity, amongst other physical characteristics of the fibres suitable for preparing bulky and resilient nonwovens, are disclosed. These new fibres allow for polyolefin nonwovens to be used in technologies previously excluded to polyolefin fibres due to their hitherto inadequate bulk or resilience and hitherto limited to or dominated by polyesters and nylons.

### BACKGROUND OF THE INVENTION

Conventional polypropylene stable fibres do not provide nonwovens with high resilience and bulkiness, at least not to the extent of polyester fibres.

Fibres from conventional polyolefins such as polypropylene and polyethylene are inadequate to provide nonwovens with enough bulk and resilience to provide a suitable alternative to polyester nonwovens.

Conventional polyolefin fibres have a bulk of approximately 20-25 cm³/g and a resilience of approximately 85%. The inventors are part of a group that have commercialized a polyolefin fibre product with improved bulk but wherein the resilience was dramatically decreased. Fibervisions HY-Comfort® fibres have an improved bulkiness of up to 45 cm³/g but with a resiliency of less than 50%. However, and notably, the HY-Comfort® fibres do not produce nonwovens with a bulk comparable to polyesters. It would be of great commercial interest to increase the bulk of a non-woven made from polyolefin fibre.

Polyester nonwovens, depending on the oven bonding method and the finish type, have a bulk of approximately 100 cm³/g and a resilience of approximately 75%.

U.S. Pat. No. 6,388,013 is directed to polyolefin fibres with improved balance of properties including increased tenacity, modulus and elongation were described. This was accomplished by incorporating from 1 to 10 weight percent aromatic hydrocarbon resin in the polypropylene fibre-forming composition which was based on a propylene homopolymer or copolymer or blend of these propylene polymer resins with a non-propylene-containing resin. The present invention provides polyolefin fibres with improved tenacity obtained by the addition of a small amount of aromatic hydrocarbon resin to the polyolefin. Polypropylene fibres extruded and drawn from the blend exhibited higher tenacity and thus have the ability to be processed at higher speeds and in finer deniers.

U.S. Pat. No. 5,770,532 describes a method for solidifying a fibre fleece which is made of artificial staple fibres including polyester, polyethylene, or polypropylene fibres, or of spun filaments of artificial fibre-forming materials including polyester, polyethylene or polypropylene and produced in a thickness as much as 10 mm or more without binding fibres, including bicomponent or special melt fibres, and without binding agents and which may be mixed with natural fibres, characterized in that the fleece is solidified solely by a single water needling operation with a water pressure of only 60 bars at most.

U.S. Pat. No. 5,589,256 is directed to a method of producing easily densified high bulk fibres that have adhered particulates. The high bulk fibres have hydrogen bonding or coordinate covalent bonding functionalities, and a binder is applied to the fibres to bind the particles to the fibres. The binder has a functional group that forms a hydrogen bond or a coordinate covalent bond with the particles, and a functional group that forms a hydrogen bond with the fibres. A substantial portion of the particles that are adhered to the fibres are adhered In particulate form by hydrogen bonds or coordinate covalent bonds to the binder, and the binder is in turn adhered to the fibres by hydrogen bonds. The fibre product comprises individualized fibres densified by applying pressure, having a density of 0.1 to 0.7 g/cc, and hydrogen bonding functionalities; and particles that are bound to the fibres by a binder interposed between the particles and the fibres, the particles having a hydrogen bonding or coordinate covalent bonding functionality, and the binder having a functional group capable of forming a binder-particle hydrogen bond or a binder-particle coordinate covalent bond and a functional group capable of forming a binder-fibre hydrogen bond. The binder may be selected from the group consisting of (a) a polymeric binder with repeating units, wherein each repeating unit has a functional group capable of forming a hydrogen bond or a coordinate covalent bond with the particles, or a hydrogen bond with the fibres; and (b) a nonpolymeric organic binder, wherein the product comprises 0.05-80% of said bound particles, said bound particles bound to the fibres primarily by a hydrogen bond or coordinate covalent bond.

U.S. Pat. No. 5,478,646 describes a polypropylene fibre high in strength and having an average size of 10,000-0.1 denier obtained by extruding a raw material composed mainly of a polypropylene having a syndiotactic pentad fraction of 0.7 or more and optionally stretching the resulting extruded material.

U.S. Pat. No. 5,204,174 relates to a nonwoven web consisting of highly drawn and unoriented thermoplastic fibres formed from a blend of propylene polymer and butylene polymer, wherein the blend by weight is from 90% to 50% polypropylene and from 10% to 50% polybutylene. The resulting nonwoven webs have enhanced toughness, tear resistance, drape, and conformability.

U.S. Pat. No. 4,563,392 relates to a coated polyolefin fibre comprising (a) a monofilament or multifilament fibre of polyethylene or polypropylene of weight average molecular weight at least about 500,000 having, in the case of polyethylene, a tenacity of at least about 15 gidenier and a tensile modulus of at least about 300 g/denier and, in the case of polypropylene, a tenacity of at least 8 g/denier and a tensile modulus of at least about 160 g/denier; and (b) a coating on the monofilament and on at least a portion of the filaments of the multifilament containing a polymer having ethylene or propylene crystallinity, said coating being present in an amount between about 0.1% and about 200%, by weight of fibre.

None of the prior art is directed to nor accomplishes the increase in the bulk of polyolefins nonwovens to an appreciable amount. The present inventors have found a solution to the problem of lack of bulk in polyolefin nonwovens.

### SUMMARY OF THE INVENTION

The invention is based on novel polyolefin fibres which are suitable for improving the bulk of non-wovens made therefrom.

A first aspect of the Invention relates to a novel polyolefin based polymer fibre, said fibre is suitable for preparing a nonwoven with high bulk. The fibre of the invention is based on polyolefin polymer, and has at least one of the features selected from the group consisting of
i) a fibre/fibre friction of no more than 600 g;
ii) a spin finish comprising essentially of an emulsion of polysiloxanes;
iii) a draw ratio of at least 1:1.5; and
iv) a fibre crystallinity of at least 50%.

A further aspect of the invention Is directed to a method of preparing a polyolefin-based fibre, said method characterised in the use of a nucleated polymer, a draw ratio of at least 1:1.5, typically with a final fibre fineness of 2 to 10 dtex, and a spin finish comprising essentially of an emulsion of modified polysiloxanes.

The present invention reveals that high fibre bulk does not necessarily correspond to high non woven bulk. The present invention reveal important fibre properties that can be used to define the fibre characteristics which in turn corresponds to high nonwoven bulk, including the selection of the spin finish; and/or the selection of the polymer grade used to make the fibres and/or the selection of the draw ratio in the preparation of the fibre. An important object of non-woven material prepared from a polyolefin-based staple fibre as defined herein. A further object of the invention is directed to a non-woven material based on polyolefin-based staple fibre, wherein the non-woven material has a bulk of at least 30 cm³/g and a resilience of at least 50%.

An interesting aspect of the present invention relates to the method of producing bulky nonwovens from polyolefin based fibres, where said nonwovens are comparable in bulk and resilience to polyester materials. Using new fibres, the appropriate preparation methods or bonding method, the present inventors have prepared nonwovens with a bulkiness of up to almost 80 cm³/g and a resilience of almost 86%. This compares favourably with conventional nonwovens made from conventional polyolefin fibres, said nonwovens having an approximate bulk of 22 cm³/g and a resilience of approximately 86%. An important object of the invention relates to a method of preparing a non-woven material comprising the use of a fibre as of the invention, or the use fibre prepared according the method of preparing fibres of the invention

Further aspects of the invention relates to a hygiene product comprising a non-woven material of the invention and to a process for the preparation of a hygiene product comprising the use of a non-woven material of the invention.

### DESCRIPTION OF THE INVENTION

The terms “bulk” and “bulkiness” as used herein are intended to relate to voluminosity, that is to say a high volume per weight and measured in cm³/g.

The term “fibre/fibre friction” as used herein is intended to mean the force needed to separate the fibres from each other.

The term “fibre crystallinity” as used herein is intended to mean the presence of three-dimensional order on a molecular level in the polymer, said fibre crystallinity being measured by Differential Scanning Calorimetry (DSC) and X-Ray Diffraction (XRD).

The term “resilience” as used herein is intended to mean the recovery to original shape and size after removal of the load or strain that caused the deformation, e.g. the ability to reorder back to the original shape or state after having been compressed.

The present investigators have prepared a non-woven material from polyolefin-based fibres which have bulk and resilience comparable to polyester fibres, thus expanding the utility of polyolefin fibres and nonwovens to a plethora of industrial applications which previously excluded products based on polyolefin fibres due to their hitherto inadequate bulk or resilience.

The present inventors have surprisingly found that high fibre bulk does not necessarily correspond to high nonwoven bulk. The present inventors have found that low fibre to fibre friction results in higher bulk for the nonwoven compared to fibres having higher fibre/fibre friction. Without being bound to a particular theory, this is due, at least in part, to a greater ease of the low friction fibres to move freely during the carding and thermobonding processes used. These low friction fibres have low fibre bulk due to their slick character.

The bulk of the non-woven material is dependent, at least in part, on features of the polyolefin fibres. The present investigators have found that the fibre characteristics greatly influences the bulk of the non-woven and have prepared fibres which are suitable for the preparation of nonwovens which have the desired bulk.

A first object of the invention relates to fibres suitable for the preparation of bulky non-wovens. The present investigators have identified the features of the fibre, any of which are necessary for obtaining the bulky nonwovens, namely the fibre to fibre friction which can be controlled, at least in part by the selection of a spin finish comprising essentially of an emulsion of polysiloxanes; a suitable draw ratio; and a suitable fibre crystallinity. The present investigators have found that the adequate setting of any one of these parameters allows for the preparation of fibres which allow for bulky non-wovens. Thus, the fibre based on polyolefin polymer is to have at least one of the features selected from the group consisting of
i) a fibre to fibre friction of no more than 600 g;
ii) a spin finish comprising essentially of an emulsion of polysiloxanes;
iii) a draw ratio of at least 1:1.5, typically with final fibre fineness of 2 to 10 dtex;
iv) a fibre crystallinity of at least 50%.

As stated, the fibre to fibre friction is an important parameter to adequately set in order to obtain the bulky polyolefin-non wovens. In a preferred embodiment, the fibre to fibre friction of no more than 500 g, such as no more than 400 g. The fibre/fibre friction is typically between 200 to 1000 g, such as 200 to 800 g, preferably 200 to 600 g, more preferably 200 to 500 g, most preferably 200 to 400 g.

The investigators of the present invention have found that the type of spin finish has a remarkable influence on the fibre bulk. It has been found that the type of spin finish to a certain extent controls the fibre/fibre friction, which to a certain extent controls the fibre bulk. Hence, a spin finish rendering a low fibre/fibre friction to the fibre has been found to exhibit a low fibre bulk. Without being bound to any specific theory, it is suggested that this effect is caused by the slick character of the fibres, where said fibres are unable to separate from each other which therefore renders a relative low fibre bulk.

As stated, fibre to fibre friction is dependent, at least in part, on the selection of spin finish. In the present context, “spin finish” is intended to mean a liquid composition which can be applied to the fibres at the spinning process (first finish) and at the subsequent stretching process (second finish). The spin finish facilitates the spinning process by lubricating the fibres and rendering them antistatic, amongst others. Antistatic agents may be used to ensure that the fibres do not become electrically charged during the spinning and stretching process; anionic, cationic and non-ionic antistatic agents may be employed in spin finishes as specified herein. The total amount of antistatic agent applied to the fibres is preferably as low as possible while still achieving the desired antistatic effect, e.g. between 0.01 and 0.5%, preferably between 0.02 and 0.35% and still more preferably between 0.05 and 0.2% by weight based on the weight of the fibres. The amount of antistatic agent is also preferably kept to a minimum in the second spin finish. Preferably, the amount of spin finish applied during the spinning process is greater than the amount applied during the stretching process. When the second spin finish comprises a cationic antistatic agent, said cationic antistatic agent is preferably present in an amount of at the most 20%, more preferably at the most 10%, based on the total active content of the second spin finish.

The spin finish may further contain an amount of cohesion conferring agent in order to ensure that the filaments are held together in bundles. This in return allows for the fibres to be processed without becoming entangled. Examples of cohesion conferring agents utilised for this purpose are neutral vegetable oils, long chained alcohols, ethers and esters, sarcosines and non-ionic surface active agents as specified herein.

The spin finish may further contain lubricants which regulate both fibre/fibre and fibre/metal friction during the production process, so that the filaments do not become worn or frayed during processing. In particular, fibre/metal friction during the spinning stage, fibre/metal friction against the stretch rollers, and fibre/fibre and fibre/metal friction in the crimper need to be regulated.

The spin finish typically further contain water plus emulsifiers or surface active agents which keep the more or less lipophilic components in the aqueous solution. Water is a preferred solvent in the present invention; other solvents should be avoided if at all possible in order to eliminate possible environmental hazards.

The fibres of the invention typically comprise a spin finish comprising essentially of an emulsion of polysiloxanes. More typically, the fibres of the invention comprise a spin finish which consists essentially of an aqueous emulsion of polysiloxanes. The aqueous emulsion of polysiloxanes suitable for use in the spin finish typically comprise at least 25% active content, such as at least 30% active content, preferably at least 35% active content, such as about 40%. The spin finish is suitably applied at a concentration of 2-15%, such as 5-10%.

In a typical embodiment, the fibres have a spin finish level of about 0.2 to 1% wt/wt with respect to the fibre, such as 0.25 to 0.9%, preferably 0.3 to 0.85%, more preferably 0.35 to 0.85%.

Without being bound to any specific spin finish, a particularly suitable spin finish according to the present invention is the Synthesin 7490 FILL®. This spin finish comprises a silicone based elastomer comprising, amongst others, an emulsion of modified polysiloxanes. A plethora of finishes which, like Synthesin 7490 FILL®, comprise an emulsion of modified polysiloxanes are suitable. The spin finish is suitably soluble in water at ambient temperature, and it may be applied by dipping, padding or spraying. The spin finish cross-links when dried at a temperature of approximately 100° C., such as 80° C.

The spin finish may be applied in two or more stages. The total concentration of suitable active components in the spin finish, i.e. antistatic agent, lubricant(s), emulsifier and cohesion conferring agent is typically lower in the first spin finish (generally 0.7-2.5% active content) than in the second spin finish (generally 4-12% active content). The viscosity of the first spin finish is thus normally lower. It may therefore be advantageous to employ any high viscosity components in the dispersion with the lowest viscosity, i.e. in the first spin finish.

A further important feature of the fibre to achieve a high bulk in the non-woven is the fibre crystallinity. As stated, the crystallinity of fibre is suitably at least 50%. In embodiments wherein the fibre crystallinity is manipulated in order to achieve high bulk in the non-wovens, the fibre crystallinity is preferably at least 55%10, such as at least 60%, as measured by DSC or XRD.

In a further aspect of the present invention, the bulk may be controlled by the selection of the polymer grade (or matrix polymer) used in the preparation of the fibre. The polymer may be selected from polypropylene homopolymers as well as random copolymers thereof with ethylene, 1-butene, 4-methyl-1-pentene, etc., and linear polyethylenes of different densities, such as high density polyethylene, low density polyethylene and linear low density polyethylene and blends of the same. The polymeric material may be mixed with other non-polyolefin polymers, such as polyamide or polyester, provided that the polyolefins still constitute the largest part of the composition.

In yet another aspect of the present invention, the fibre bulk may be controlled by the selection of the nucleating agent, e.g. the nucleating agent used in the raw polyolefin material. Nucleating agents are often commonly used in industrial practice in combination with crystallizable thermoplastic polymers to impart improved characteristics such as improved mechanical properties. Typical nucleating agents known are metallic salts of aliphatic or aromatic carboxylic acids, branched polymers containing dendrittic branches and minerals such as chalk, gypsum, clay kaolin, mica, talc and silicates. More recently developed nucleating agents dissolve in the polymer melt such as compounds that are based on D-sorbitol and 1,3-2,4-bis-(3,4-dimethylbenzylidene)-D-sorbitol.

The effect of the nucleating agent is to initiate the crystallisation process in the parent polymer. The nucleation agents constitute a very high surface area, and they are preferred nucleation sites in the parent polymer. The nucleation process is a thermodynamic process which substantially is driven by a lowering of the specific surface area of said nucleating agents, e.g. by the lowering of the specific surface area of chalk particles or talc particles in the parent polymer.

The nucleation agent also promotes the polymer crystallisation process. Hence, the nucleation agent may render the parent polymer more or less crystalline, e.g. substantially more amorphous than crystalline, or substantially more crystalline than amorphous. In the present context, “crystalline” is intended to mean crystalline regions within the amorphous polymer matrix, e.g. regions in which the polymer chains or parts of the polymer chains are aligned in regular patterns substantially parallel to one another. In contrast, “amorphous” is intended to mean areas within the polymer matrix in which substantially no alignment or ordering of the polymer chains is present.

In a preferred embodiment, the polyolefin is selected from the group consisting of isotactic or syndiotactic polypropylene homopolymers, homo- and co-polymers of monoolefins such as ethylene, propylene, alpha-olefins, 4-methyl-1-pentene and blends thereof, linear polyethylenes, high density polyethylene, low density polyethylene, and linear low density polyethylene and blends of the same. More preferably, the polyolefin is selected from the group consisting of homopolymer polypropylene and homopolymer polyethylene. Most preferably, the polyolefin is homopolymer polypropylene.

The degree of crystallinity is, at least in part, controlled by the nucleating agent. This, in turn, also affects the mechanical properties of the polymer. For example, polymer chains or parts of the polymer chains that are closely packed in the crystalline regions will render more polymer chains per unit area to support a given stress. Also, since the polymer chains are in close and regular contact over relatively long distances in the crystallites, the secondary forces holding them together are cumulatively greater than in the amorphous regions. Hence, a substantially more crystalline polymer will increase the strength and the rigidity of the polymer.

In a typical embodiment of the invention, the polyolefin polymer is a nucleated polymer. Suitably, the nucleating agent is selected from the group consisting of talc, chalk, gypsum, clay, kaolin, silicates, aromatic carboxylic acid salts, phophate ester salts, and sorbitol based compounds. Most suitably, the nucleating agent is talc. In the embodiment wherein the polyolefin polymer is a nucleated polymer, nucleated with talc, nucleation is typically to a level of 5000 to 10000 ppm of talc.

Without being bound to any specific polymer grade, a preferred raw material polypropylene polymer grade, when used in the present invention, may be the Adstif HA840R. The Adstif HA840R is an advanced homopolymer which features an extremely high stiffness and gloss. The polymer grade is nucleated with 8500 ppm of talc to enhance the crystallinity. In a further aspect of the present invention, fibres produced from the Adstif HA840R homopolymer raw material renders fibres with a higher flexural modulus as compared with fibres produced from standard polypropylene material. Without being bound to any specific theory, it is suggested that the higher flexural modulus obtained through the Adstif HA840R is due to the fact that the homopolymer is nucleated with talc. The nucleated homopolymer is therefore more crystalline and hence more stiff. For example, the Adstif HA840R, as used in the present invention, has a flexural modulus of approximately 2250 MPa. As compared to this value, a conventional raw material polypropylene homopolymer grade, such as the PPH7059, has a flexural modulus of approximately 1450 MPa.

As the fibre bulk is controlled, at least in part, by the selection of the draw-ratio in the preparation of the fibre. In the present context, “draw-ratio” or “stretch ratio” is intended to mean the ratio between the speed of the last and first set of rollers.

The fibres of the present invention are typically stretched using a draw ratio of from about 1:1.5 to about 1:8, such as about 1:1.5 to 1:6, such as about 1:1.5 to 1:4, about 1:2 to 1:8, about 1:2 to 1:6, or about 1:2 to 1:4 for polypropylene fibres, and from 1:2 to 1:4.5 for polyethylene fibres and polypropylene/polyethylene bicomponent fibres, resulting in an appropriate fineness, typically such as about 2 to 20 dtex, such as 2 to 10 dtex, typically 3 to 9 dtex, most typically 5 to 8 dtex. The draw-ratio has an influence on the crystallinity, that is, at larger draw ratios the polymer chains will become increasingly more aligned and hence more crystalline. Larger draw-ratios will also tend to orient the crystalline regions substantially along the fibre length rendering these fibres substantially anisotropic. Increasingly crystalline fibres will result in increasingly stiff fibres, e.g. the higher the crystallinity and the orientation of the crystals the higher the stiffness of the fibre.

Preferably, the draw ratio of a polypropylene fibre suitable to obtain a nonwoven with a high bulk is typically in the range 1:2 to 1:4. Typically, the polypropylene fibre according to the present invention has a draw ratio of about 1:1.5 to 1:6, such as about 1:2 to 1:5, preferably 1:2.5 to 1:4.

According to the present invention, a high crystallinity of the individual fibres renders a bulky nonwoven material, e.g. more crystalline and hence more stiff fibres render a more voluminous appearance of the nonwoven material. Without being bound to any specific theory, it is suggested that when the nonwoven material is acted upon with an external force, the high-crystalline fibres have the ability to deflect somewhat and reorder to the initial state due to the inherent stiffness of the fibres. This feature is quantified, at least In part, through the resiliency. Resiliency is intended to mean the ability to recover to original shape and size after removal of a load or strain that causes a deformation. The resilience of the fibre suitable for the preparation of a bulky non-woven is typically about at least about 30%, such as at least about 40%, such as about 42%.

The bulk of a fibre suitable for preparing a bulky non-woven, as stated, does not necessarily correlate with the bulk of the non-woven. Typically, however, the fibres of the invention suitable for the preparation of a bulky non-woven have a bulk of at least about 20 cm³/g, preferably at least about 30 cm³/g and 35 cm³/g, such as at least about 40 cm³/g.

The flexural modulus of a polyolefin used in the preparation of a fibre suitable for preparing a bulky non-woven according to the present invention, is typically at least 1200 MPa, such as at least 1500 MPa.

As stated, the adequate control of any one the features of a fibre selected from the group comprising the fibre to fibre friction; the spin finish; the draw ratio; and the fibre crystallinity results in a fibre suitable for the preparation of a bulky non-woven. Preferably, the fibre based on polyolefin polymer according to the invention, has at least two of the features selected from the group consisting of
i) a fibre/fibre friction of no more than 600 g;
ii) a spin finish comprising essentially of an emulsion of polysiloxanes;
iii) a draw ratio at least 1:1.5;
iv) a fibre crystallinity of at least 50%;
v) the polyolefin polymer is a nucleated polymer;
vi) the polyolefin has a flexural modulus of at least 1500 MPa;
vii) an ST dtex value of 2 to 20 dtex; and
viii) a fibre bulk of 20 cm³/g, preferably at least about 30 cm³/g.

Suitably, the fibre of the invention have at least three of the features, such as at least four of the features, such as at least five, six, seven, or eight of features selected from the group consisting of
i) a fibre/Fibre friction of no more than 600 g;
ii) a spin finish comprising essentially of an emulsion of polysiloxanes;
iii) a draw ratio of at least 1:1.5;
iv) a fibre crystallinity of at least 50%;
v) the polyolefin polymer is a nucleated polymer;
vi) the polyolefin has a flexural modulus of at least 1500 MPa;
vii) an ST dtex value of 2 to 20 dtex; and
viii) a fibre bulk of 20 cm³/g, preferably at least about 30 cm³/g.

More preferably, the fibre of the present invention has at least two of the features selected from the group consisting of
i) a fibre/fibre friction of no more than 600 g;
ii) a spin finish comprising essentially of an emulsion of polysiloxanes;
iii) a draw ratio of at least 1:1.5;
iv) a fibre crystallinity of at least 50%, and
v) the polyolefin polymer is a nucleated polymer.

Suitably, the fibre of the present invention has at least two of the features selected from the group consisting of
i) a fibre/fibre friction of no more than 600 g;
ii) a spin finish comprising essentially of an emulsion of polysiloxanes;
iii) a draw ratio of at least 1:1.5;
iv) a fibre crystallinity of at least 50%,
v) the polyolefin polymer is a nucleated polymer; and and at least one of the features, such as at least two of features selected from the group consisting of
vi) the polyolefin has a flexural modulus of at least 1500 MPa;
vii) an ST dtex value of 2 to 20 dtex; and
viii) a fibre bulk of 20 cm³/g, preferably at least about 30 cm³.

In a most preferred embodiment, the fibre based on polyolefin polymer according to the present invention is such that the polyolefin polymer is a nucleated polymer, and said fibre has
i) a fibre/fibre friction of no more than 600 g;
ii) a spin finish comprising essentially of an emulsion of polysiloxanes;
iii) a draw ratio of at least 1:1.5; and
iv) a fibre crystallinity of at least 50%.

A further object of the invention relates to a non-woven material prepared from a polyolefin-based staple fibre as defined supra.

The present invention further relates to a method for preparing a nonwoven fabric from staple fibres, the method comprising the steps of (a) forming a fibrous web comprising staple fibres according to the fibre specifications herein, and (b) bonding the fibrous web. In particular, the staple fibres exhibit a low fibre/fibre friction, e.g. such as no more than 600 g, such as no more than 400 g, suitably no more than 300 g.

Alternatively defines, the non-woven material of the invention is based upon polyolefin-based staple fibres, and wherein the non-woven material has a bulk of at least 30 cm³/g and a resilience of at least 50%. Typically, the non-woven material has a resilience of at least 55%, such as at least 60%.

Typically, the nonwoven material has bulk of at least 35%, such as at least 40%, preferably at least 45%, more preferably at least 50%, even more preferably at least 55%, most preferably at least 60%.

A further object of the invention relates to a method of preparing a polyolefin-based fibre, said method characterised in the use of a nucleated polymer, a draw ratio of at least 1:1.5, and a spin finish comprising essentially of an emulsion of modified polysiloxanes.

In a preferred embodiment of the present invention, the fibres as disclosed herein are polyolefin-based staple fibres or co-polymers thereof. Polyolefins used to produce such fibres include polyolefins selected from the group consisting of isotactic or syndiotactic polypropylene homopolymers as well as random copolymers thereof with ethylene, 1-butene, 4-methyl-1-pentene, etc., and linear polyethylenes of different densities, such as high density polyethylene, low density polyethylene and linear low density polyethylene and blends of the same. The polymeric material may be mixed with other non-polyolefin polymers, such as polyamide or polyester, provided that the polyolefins still constitute the largest part of the composition. The polymer is suitably selected form polyethylene and polypropylene.

The melts used to produce the polyolefin containing fibres may also contain various conventional fibre additives, such as calcium stearate, antioxidants, process stabilisers, compatibilizers and pigments including whiteners such as TiO₂ and/or other colorants.

The fibres may be either monocomponent or bicomponent fibres, the latter being, for example, sheath-and-core type bicomponent fibres with the core being located either eccentrically (off-centre) or concentrically (substantially in the center). Bicomponent fibres will typically have a core and sheath which comprise, respectively, polypropylene/polyethylene, high density polyethylene/linear low density polyethylene, polypropylene random copolymer/-polyethylene, or polypropylene/polypropylene random copolymer. The cross-sectional shape of the fibre can further be circular, three-lobal, four-lobal or possess hollow cores in addition to the shape.

The spinning of the fibres is preferably accomplished using conventional melt spinning, also known as long spinning, with the spinning and stretching being performed in two separate steps. Alternatively, other means of manufacturing staple fibres, in particular “compact spinning”, which is a one-step operation, may be utilised to carry out the invention.

For spinning, the polyolefin containing material is extruded and the polymer melt is passed through the holes of a spinneret. The extrudates are subsequently cooled and solidified by a stream of air and at the same time drawn into filaments. After having solidified, the filaments are treated with the first spin finish. This is typically performed by means of lick rollers. Alternative systems such as spraying of the bundles of filaments or dipping them in the spin finish, are also suitable.

The amount of fibre degradation influences the thermobonding properties. Hence, too low a fibre degradation tends to give poor thermobonding properties to the fibres, as well as poor processability on the spinning line. The degradation of the polymer depends on the amount of stabilizers in the polyolefin-containing material, the temperature of the extruder and the speed and temperature of the quenching air. A means to determine the level of degradation of the as-spun fibres is to measure the melt flow rate (MFR) of the fibre and compare this with the MFR of the initial polymeric material. In a preferred embodiment of the present invention, the MFR of the as-spun fibres is between 1.5 and 7 times the MFR of the raw material, typically between 2 and 5 times the MFR of the raw material. It should however be noted that this to a certain extent is dependent upon the MFR of the raw material. Thus, the preferred ratio between fibre MFR and raw material MFR will often be slightly lower for a raw material with a relatively high MFR, e.g. 3-5 times for a raw material with an MFR of 10-15 and 2-4 times for a raw material with an MFR of 15-25.

The stretching process typically involves a series of hot rollers and a hot air oven. The filaments first pass through one set of rollers, followed by passage through a hot-air oven, and then passage through a second set of rollers. Both the hot rollers and the hot air oven typically have a temperature of about 50-140° C., such as about 70-130° C., the temperature being chosen according to the type of fibre; typically 115-135° C. for polypropylene fibres, 95-105° C. for polyethylene fibres, and 110-120° C. for polypropylene/polyethylene bicomponent fibres. The speed of the second set of rollers is faster than the speed of the first set, and hence the heated filaments are stretched accordingly. A second oven and a third set of rollers can also be used (two-stage stretching), with the third set of rollers having a higher speed than the second set. Similarly, additional sets of rollers and ovens may be used. The stretch ratio is the ratio between the last and the first set of rollers. The fibres of the present invention are typically stretched using a stretch ratio of from about 1:1 to about 1:10.

After stretching, the bundles of filaments are treated with the second spin finish, for example using lick rollers or by spraying or dipping.

The stretched fibres are normally texturized (crimped) in order to render the fibres suitable for carding, e.g. by giving them a “wavy” form. An effective texturization, i.e. a relatively large number of crimps in the fibres, allows for high processing speeds in the carding machine, e.g. at least 80 m/min, typically at least 150 m/min or even 200 m/min or more, and thus a high productivity.

Crimping is conveniently carried out using a so-called stuffer box or, as an alternative, the filaments can be air-texturized. In certain cases, i.e. for asymmetric biocomponent fibres, crimping devises may be eliminated since the heat treatment of such fibres leads to three-dimensional self-crimping.

The fibres of the present invention are typically texturized to a level of about 5-15 crimps/cm, typically about 7-12 crimps/cm, the number of crimps being the number of bends in the fibres.

A third treatment of spin finish may optionally be applied to the filaments after the crimper, e.g. by a spraying method.

After crimping, the filaments are typically led through a hot air oven for fixation and drying. The temperature of the oven depends on the composition of the fibres, but most obviously be below the melting point of the lowest melting component. The temperature of the oven is typically in the range of 90-130° C., e.g. 95-125° C. The heat treatment also removes a certain amount of the water from the spin finishes. The drying process, which is an important factor for, e.g. rendering the finish insoluble by possible cross-linking and consequently impart permanent properties. The residual moisture content is preferably less than 2.0%, more preferably less than 1.0% by weight based on the weight of the fibre.

The dried filaments are then led to a cutter, where the filaments are cut to staple fibres of the desired length. The fibres of the present invention are typically cut to staple fibres of a length of about 18-180 mm, more typically about 25-100 mm, in particular about 30-75 mm.

At any of three points on the fibre line, i.e. after spinning, after stretching or after the crimper, an antistatic agent may be applied. The antistatic agent is preferably non-ionic, such as phosphate ester, or anionic such as a phosphate salt, while cationic antistatic agents are less preferred. In a preferred embodiment of the present invention, the antistatic agent is however applied after the crimper.

The method of preparing the non-woven material of the invention typically comprises the step of preparing fibres with a draw ratio of the fibres of 1:2 to 1:8, such as 1:2 to 1:6.

The method of preparing the non-woven material of the invention typically comprises the step of using a spin finish consisting essentially of an aqueous emulsion of polysiloxanes, with at least 25% active content, such as at least 30% active content, preferably at least 35% active content, such as about 40%. The spin finish is suitably applied at a concentration of 2-15%, such as 5-10%. The spin finish level is suitably 0.2 to 1% wt/wt with respect to the fibre, such as 0.25 to 0.9%, preferably 0.3 to 0.85%, more preferably 0.35 to 0.85%.

The invention is further directed to a method of preparing a non-woven material comprising the use of a fibre as defined herein, or the use fibre prepared as defined herein.

In the preparation of the non-woven material of the invention, the fibres are oven-bonded at a temperature of 130 to 150° C., such as 132 to 148° C., preferably at 134 to 144° C., suitably using an appropriate bicomponent bonding fibre such as ES-FiberVisions fibre type ES-C Cure.

A further aspect of the invention relates to a hygiene product comprising a non-woven material as defined herein. A further object of the invention relates to a process for the preparation of a hygiene product comprising the use of a non-woven material as defined herein.

The fibres described in the examples below are characterised according to various parameters which are important in determining the fibre bulk and the non woven bulk respectively. Most prominent of these parameters are the crystallinity and the fibre/fibre friction. Both the bulk and the resiliency of the fibre and the non woven are determined according to any one of the standard methods known to the person skilled in the art

All the measurements are measured according to ISO 554 Standard Atmosphere 23/50.

The degree of fibre crystallinity can be determined as measured by Differential Scanning Calorimetry (DSC) or by X-ray Diffraction (XRD), both methods of which are known to the person skilled in the art.

Bulk and resiliency may be measured according to Inda Standard test “Measuring Compression and Recovery of Highloft Nonwoven” IST 120.3-92. This method has also been adapted to measure bulk and resiliency of fibres.

### EXAMPLES

### Example 1

The bulk and the resiliency of various fibres and their corresponding nonwovens are given in Table 1 below.

As can be seen from the data submitted in Table 1, a number of parameters have an influence on the bulk and resiliency of both the fibre and the nonwoven: The type of matix polymer used, the type of spin finish applied during the drawing process and the drawing ratio, amongst others. Further two more parameters are measured, namely the fibre/fibre friction and the fibre crystallinity, which parameters to some extent are dependent also on the type of matix polymer used, the type of spin finish applied during the drawing process and the drawing ratio. Hence, the bulk and the resiliency of the fibre and the nonwoven are directly dependent on the type of matrix polymer, the type of spin finish, the draw ratio, and indirectly dependent on the fibre/fibre friction and the crystallinity, e.g. these features merely reflect the type of matrix polymer used, the type of spin finish used and the draw ratio used in the manufacturing process. The fibre/fibre friction and crystallinity values are used to help determine the relationship between the numerous parameters in the present invention. The crystallinity is measured by both Differential Scanning Calorimetry (DSC) and X-ray diffraction (XRD) and the fibre/fibre friction is measured according to the method as described herein.

TABLE 1
Data summary. Note that sample 1 is used as a reference (conventional PPH 7059 matrix polymer,
without nucleation agent and a conventional spin finish, Silastol GF18).

| | | | | | | | | | Crystallinity | | | | | |
|---|---|---|---|---|---|---|---|---|---|---|---|---|---|---|
| | Matrix | Spin | | Draw | Finish type | | Fibre | Friction | (%) | | Bulk cm³/g | | Resiliency % | |
| Sample | Polymer | Finish | dtex | ratio | Draw | Spray | dtex | (g) | DSC | X-ray | Fibre | NW | Fibre | NW |
| 1 | PPH 7059 | GF18 | 8.4 | 1:1.45 | GF18 | — | 6.7 | — | 53 | 49 | 57 | 28 | 46 | 86 |
| 2 | PPH 7059 | GF602-c | 16 | 1:2.8 | GF602-c | | 6.7 | 625 | 56 | 64 | 57 | 22 | 46 | 86 |
| 3 | PPH 7059 | GF602-c | 16 | 1:2.8 | 7490-FILL | PP920 | 6.7 | 405 | 58 | 72 | 41 | 64 | 55 | 73 |
| 4 | HA 840 R | GF602-c | 16 | 1:2.8 | GF602-c | — | 6.7 | 629 | 62 | 69 | 66 | 30 | 43 | 79 |
| 5 | HA 840 R | GF602-c | 16 | 1:2.8 | 7490-FILL | PP920 | 6.7 | 379 | 61 | 77 | 48 | 65 | 49 | 74 |
| 6 | PPH 7059 | GF602-c | 11 | 1:2 | GF602-c | — | 6.7 | 781 | 57 | 57 | — | 29 | — | 83 |
| 7 | HA 840 R | GF602-c | 11 | 1:2 | GF602-c | — | 6.7 | 704 | 60 | 60 | — | 38 | — | 84 |
| 8 | HA 840 R | GF602-c | 16.1 | 1:4 | 7490-FILL | PP920 | 6.7 | 608 | 68 | 68 | 58 | 79 | 47 | 75 |
| 9 | PPH 7059 | GF602-c | 7.2 | 1:1.32 | 7490-FILL | PP920 | 6.7 | 275 | 56 | 56 | 32 | NA | 53 | NA |
| 10 | HA 840 R | GF602-c | 7.2 | 1:1.32 | 7490-FILL | PP920 | 6.7 | 407 | 62 | 62 | 37 | NA | 56 | NA |
| | PET-ref. | PET | | | | | 6.7 | | | | 78 | 104 | 42 | 74 |

Table 1 demonstrates that the present investigators have surprisingly found that both the type of matrix polymer and the type of spin finish are important in respect to the bulk and resiliency of the fibre and the nonwoven.

Trends reflected in the data from Table 1 demonstrate that fibres with Synthesin 7490 FILL applied in the drawing process have a lower fibre/fibre friction than fibres in which only Silastol GF602-c is applied. This effect is rendered clear when samples number 2 and 4 are compared with samples 3 and 5.

Furthermore, fibres with Silastol GF602-c applied have an Improved bulk (fibre bulk as opposed to non-woven bulk), compared to fibres with Synthesin 7490 FILL applied in the drawing process. This is rendered clear when samples number 2 and 4 are compared with samples 3 and 5, Table 1.

Fibres made of Adstif HA840R (nucleated polypropylene homopolymer) have higher crystallinity as compared to fibres made of PPH7059 (non-nucleated polypropylene homopolymer). This is rendered clear comparing sample number 2 and 4 with sample number 3 and 5, Table 1.

Fibres made of Adstif HA840R (nucleated polypropylene homopolymer) have improved bulk as compared to fibres made of PPH7059 (non-nucleated polypropylene homopolymer) for the same finish applied. This is rendered clear comparing sample number 4 with sample number 2 and sample number 5 with sample number 3, Table 1.

Fibres with a high draw ratio results in a high fibre bulk and a high nonwoven bulk as compared to fibres with a lower draw ratio. In order to draw this conclusion it is necessary that the same type of polymer and spin finish is used, e.g. the conditions must be the same in order for comparison. The trend is rendered clear when comparing e.g. samples 5, 8 and 10, Table 1.

Nonwovens based on fibres with Synthesin 7490 FILL applied have improved bulk compared to nonwovens in which only Silastol GF602-c is applied. This is rendered clear when samples number 3 and 5 are compared with samples 2 and 4, Table 1.

Nonwovens based on fibres made of Adstif HA840R (nucleated polypropylene homopolymer) have improved bulk as compared to nonwovens based on fibres made of PPH7059 (non-nucleated polypropylene homopolymer). This is rendered clear when sample number 4 is compared with sample number 2 and sample number 5 is compared with sample number 3, Table 1.

### Example 2

The achieved bulk and resiliency for the fibre and the non woven are given in Table 2. The nonwovens were oven bonded using 30% ES-C bico fibres, at a bonding range of 134-140° C. Test number 1 is used as a benchmark, e.g. a conventional homopolymer (PPH 7059 matrix polymer) in which no nucleation agent has been added.

TABLE 2
Maximum bulk obtained for selected fibres and nonwovens.

| | |
|---|---|
| Bulk cm³/g | Resiliency % |

| Test Number | Fibre | Nonwoven | Fibre | Nonwoven |
|---|---|---|---|---|
| 1^{a)} | 57 | 28 | 46 | 86 |
| 2^{b)} | 41 | 67 | 55 | 76 |
| 3^{c)} | 66 | 46 | 43 | 87 |
| 4^{d)} | 48 | 74 | 49 | 76 |

^{a)}PPH 7059 matrix polymer (no nucleation), Spin finish: GF602-c, crystallinity (X-ray) = 64%
^{b)}PPH 7059 matrix polymer (no nucleation), Spin finish: Synthesin 7490 FILL, crystallinity (X-ray) = 72%
^{c)}Adstif HA840R matrix polymer (nucleated), Spin finish: GF602-c, crystallinity (X-ray) = 69%
^{d)}Adstif HA840R matrix polymer (nucleated), Spin finish: Synthesin 7490 FILL, crystallinity (X-ray) = 77%

From Table 2, sample numbers 1 and 4 should especially be noted. Sample number 1 comprises the conventional PPH 7059 matrix polymer (no nucleation) and a conventional spin finish GF602-c, whereas sample number 4 comprises a nucleated Adstif HA840R matrix polymer and a Synthesin 7490 FILL spin finish. Comparing the two samples, it can be deduced that sample number 4 exhibits a bulk value for the nonwoven which roughly corresponds to an increase of 164% (from 28 cm³/g to 74 cm³/g). According to the present invention, and without being bound to any specific theory, this surprising leap In bulkiness is believed to be caused by the combined use of a nucleated homopolymer (Adstif HA840R) with the Synthesin 7490 FILL spin sinish, which renders highly crystalline and stiff fibres. The said combination also renders fibres which have a surprisingly low fibre/fibre friction, which in return provides for a favourably high bulk of the nonwoven (e.g. the fibre/fibre movement is relative “free”).

### Example 3

The influence of the bonding temperature on the bulkiness and the resiliency is given in Table 3. The most favourable bulkiness, for the nucleated Adstif HA840R matrix polymer comprising the Synthesin 7490 FILL spin finish, is obtained at a bonding temperature of 140° C.

TABLE 3
Influence of bonding temperature on bulk and resiliency.

| | Bulkiness cm³/g | | | | Resiliency % | | | |
|---|---|---|---|---|---|---|---|---|
| Trial nr. | 134° C. | 136° C. | 138° C. | 140° C. | 134° C. | 136° C. | 138° C. | 140° C. |
| 1^{a)} | 27 | 23 | 22 | 28 | 82 | 86 | 86 | 83 |
| 2^{b)} | 51 | 56 | 64 | 67 | 76 | 75 | 73 | 75 |
| 3^{c)} | 46 | 32 | 30 | 25 | 78 | 82 | 79 | 87 |
| 4^{d)} | 57 | 57 | 65 | 74 | 75 | 76 | 74 | 75 |

^{a)}PPH 7059 matrix polymer (no nucleation), Spin finish: GF602-c, crystallinity (X-ray) = 64%
^{b)}PPH 7059 matrix polymer (no nucleation), Spin finish: Synthesin 7490 FILL, crystallinity (X-ray) = 72%
^{c)}Adstif HA840R matrix polymer (nucleated), Spin finish: GF602-c, crystallinity (X-ray) = 69%
^{d)}Adstif HA840R matrix polymer (nucleated), Spin finish: Synthesin 7490 FILL, crystallinity (X-ray) = 77%

1. A fibre comprising polyolefin polymer, said fibre having the features:
i) a fibre/fibre friction of no more than 600 g;
ii) a spin finish consisting essentially of an aqueous emulsion of polysiloxanes, with at least 25% of the active content being polysiloxanes; and
iii) a fibre crystallinity of at least 50%.

2. A fibre according to claim 1 wherein the fibre/fibre friction is no more than 500 g.

3. A fibre according to claim 1 wherein the fibre/fibre friction is 200 to 600 g.

4. A fibre according to claim 1, wherein the spin finish consists essentially of an aqueous emulsion of polysiloxanes of at least 30% active content.

5. A fibre according to claim 4, wherein the spin finish is applied at a concentration of 2-15% wt/wt active content.

6. A fibre according to claim 4, wherein the spin finish level is 0.2 to 1% wt/wt with respect to the fibre.

7. A fibre according to claim 1, wherein the fibre crystallinity is at least 55% as measured by DSC or XRD.

8. A fibre according to claim 1, wherein the polyolefin polymer is a nucleated polymer.

9. A fibre according to claim 1, wherein the polyolefin polymer is a nucleated polymer, wherein the nucleating agent is selected from the group consisting of talc, metallic salts of aliphatic or aromatic carboxylic acids, branched polymers containing dendrittic branches and minerals selected from the group consisting of chalk, gypsum, clay kaolin, mica, and silicates and compounds that are based on D-sorbitol.

10. A fibre according to claim 9, wherein the nucleating agent is talc.

11. A fibre according to claim 9, wherein the polyolefin polymer is a nucleated polymer, nucleated with 5000 to 10000 ppm of talc.

12. A fibre according to claim 1, wherein the polyolefin is selected from the group consisting of isotactic or syndiotactic polypropylene homopolymers, homo and copolymers of monoolefins such as ethylene, propylene, alphaolefins, 4-methyl-1-pentene and blends thereof, linear polyethylenes, high density polyethylene, low density polyethylene, and linear low density polyethylene and blends of the same.

13. A fibre according to claim 9, wherein the polyolefin is selected from the group consisting of homopolymer polypropylene and homopolymer polyethylene.

14. A fibre according to claim 9, wherein the polyolefin is homopolymer polypropylene.

15. A fibre according to claim 1 with a bulk of at least about 30 cm³/g.

16. A fibre according to claim 1, wherein the draw ratio is about 1:2 to 1:8.

17. A fibre according to claim 1 having an ST dtex value of 2 to 20 dtex.

18. A fibre according to claim 1 having a resilience of at least about 40%.

19. A fibre according claim 1, wherein the polyolefin has a flexural modulus of at least 1500 MPa.

20-21. (canceled)

22. A fibre comprising polyolefin polymer according to claim 1, wherein the polyolefin polymer is a nucleated polymer, and said fibre has
i) a fibre/fibre friction of no more than 600 g;
ii) a spin finish consisting essentially of an emulsion of polysiloxanes;
iii) a draw ratio of at least 1:1.5 with a final fibre fineness of 2 to 10 dtex;
iv) a fibre crystallinity of at least 50%.

23. A non-woven material prepared from a polyolefin-based staple fibre as defined in any one of claims 1-19 and 22.

24. A non-woven material comprising polyolefin-based staple fibre, wherein the non-woven material has a bulk of at least 30 cm³/g and a resilience of at least 50%.

25. A non-woven material according to claim 24, wherein the non-woven material has a resilience of at least 55%.

26. A non-woven material according to any one of claims 24 to 25, wherein the nonwoven material has bulk of at least 35%.

27. A method of preparing a polyolefin-based fibre, said method characterised in the use of a nucleated polymer, a draw ratio of at least 1:1.5 with a final fibre dtex of 2 to 10 dtex., and a spin finish consisting essentially of an emulsion of polysiloxanes.

28. A method according to claim 27, wherein the polymer is selected from polyethylene and polypropylene.

29. A method according to claim 27, wherein the draw ratio is 1:2 to 1:8.

30. A method according to claim 27, wherein the spin finish consists essentially of an aqueous emulsion of polysiloxanes, with at least 25% of the active content being polysiloxanes.

31. A method according to claim 30, wherein the spin finish is applied at a concentration of 2-15% wt/wt active content.

32. A method according to claim 30, wherein the spin finish level is 0.2 to 1% wt/wt with respect to the fibre.

33. A method of preparing a non-woven material comprising the use of a fibre as defined in any one claims 1 to 19 and 22, or the use of a fibre prepared according to the method according to any one of claims 27 to 32, comprising the steps of
(a) forming a fibrous bond comprising said fibres, and
(b) bonding the fibrous web.

34. A method according to claim 33, wherein the fibres are oven-bonded at a temperature of 130 to 150° C.

35. A fibre according to claim 1, wherein the fibre crystallinity of at least 50% is achieved by:
iv) a draw ratio of at least 1:1.5; or
v) the polyolefin polymer being a nucleated polymer.

36. A fibre according to claim 1, wherein the spin finish is an external spin finish.
